(19) United States
(12) Patent Application Publication
(10) Pub. No.: US 2018/0015965 A1
(43) Pub. Date: Jan. 18, 2018

(54) Bearing Arrangement for a Driver's Cab of a Lorry

(71) Applicant: Daimler AG, Stuttgart (DE)

(72) Inventor: Gerd Martin, Stuttgart (DE)

(73) Assignee: Daimler AG, Stuttgart (DE)

(21) Appl. No.: 15/546,510

(22) PCT Filed: Jan. 19, 2016
(86) PCT No.: PCT/EP2016/000083

§ 371 Date: Jul. 26, 2017

(30) Foreign Application Priority Data
Jan. 27, 2015 (DE) 10 2015 000 966.4

(51) Int. Cl. B62D 33/07; B62D 21/04; B62D 33/077; B62D 21/15

(52) U.S. Cl. CPC B62D 33/071; B62D 33/077; B62D 21/04; B62D 21/152

(57) ABSTRACT

A bearing arrangement for a driver's cab of a lorry is disclosed. The bearing arrangement has a respective frame-side bracket which is fastened to a laterally associated frame element of a support frame of the lorry and which has a guide, along which an allocated bearing element of a driver's cab bearing can be displaced in the event of an accident-induced application of force. The bearing element is connected to the laterally allocated frame element of the support frame via a weakening device by which the laterally allocated frame element of the support frame can be weakened in a targeted manner in the event of an accident-induced displacement of the bearing element.

### BACKGROUND AND SUMMARY OF THE INVENTION

The invention relates to a bearing arrangement for a driver's cab of a lorry.

Such a bearing arrangement is already known, for example, from DE 10 2005 014 402 A1 and, since it is about a so-called driver's cab comfort bearing, comprises a stabilizer element in the form of a stabilizer rocker which comprises a driver on each side of the vehicle, the driver being connected to a laterally corresponding spring-damper element and being mounted in a guide with one end with a bearing element on a laterally allocated, frame-side bracket. The respective bearing element of the corresponding driver can be displaced along this guide in the event of an accident-induced application of force in order to pull the driver's cab out of the danger zone, i.e., the obstacle, on the one hand and, on the other hand, still maintain a fixed connection to the frame of the vehicle.

In addition to the driver's cab comfort bearing described here, there are also so-called driver's cab standard bearings, in which, instead of via the stabilizer rocker, the respective lateral driver's cab bearing is mounted in the guide by means of the corresponding spring-damper element via the corresponding bearing element on the laterally allocated, frame-side bracket. In this respect, there is no difference in the guide of the respective bearing element on the laterally allocated bracket, whether it is a driver's cab comfort bearing or a driver's cab standard bearing.

The object of the present invention is to provide a bearing arrangement of the type mentioned at the start, the accident performance of which is further improved.

In order to create a bearing arrangement whose accident performance is further improved, it is provided according to the invention that the bearing element is connected to the laterally allocated frame element of the support frame via a weakening device, by means of which the laterally allocated frame element of the support frame can be weakened in a targeted manner in the event of an accident-induced displacement of the bearing element.

In the event of an accident-induced rearward displacement of the respective bearing element, a targeted weakening of the frame element is consequently initiated for the accident by force by means of the weakening device, the weakening advantageously influencing the deformation behavior of the support frame of the lorry. Nevertheless, a fixed connection to the frame of the vehicle is maintained. In particular, the degree of forced deformation of the frame element can be determined by means of the path along which the corresponding bearing element travels in the allocated guide of the bracket, such that the starting forces can be adjusted at the start of deformation or the connecting forces of the weakening device can be adjusted with respect to the frame element of the support frame. Thus, optimum coordination of the deformation behavior of the support frame can be achieved depending on the respective driver's cab bearing.

The present invention is equally suitable for a driver's cab comfort bearing, in which a stabilizer element is present in the form of a stabilizer rocker, which comprises a driver on each side of the vehicle, the driver being connected to a laterally corresponding spring-damper element and being mounted in a guide with one end with a bearing element on a laterally allocated, frame-side bracket, as it is for driver's cab standard bearings, in which, instead of via the stabilizer rocker, the respective lateral driver's cab bearing is mounted in the guide by means of the corresponding spring-damper element via the corresponding bearing element on the laterally allocated, frame-side bracket.

In a further embodiment of the invention, it has been found to be advantageous if the weakening device is connected to an upper flange of the laterally allocated frame element, the upper flange being able to be weakened in a targeted manner in the event of an accident-induced displacement of the laterally allocated bearing element. As a result of the weakening of the upper flange, an upward bending of the frame element can be achieved in a particularly favorable manner, which advantageously has an effect on the accident performance of the lorry.

A further advantageous embodiment provides that the frame element has a leg which has a material weakening, in particular an opening, in the fastening region of the weakening device. By means of such a material weakening, the deformation behavior of the frame element can be adjusted particularly simply and precisely, and in particular also depending on the shape and size of the selected opening.

It is also advantageous for the weakening device to comprise a profile element which is connected to the bearing element and extends at least substantially in the direction of the guide of the bearing element. This results in a particularly good coordination of the path along which the bearing element travels as a result of an accident-induced application of force, with the forced deformation of the frame element, which occurs as a result of the connection of the bearing element via the weakening device.

In this context, it has been shown to be furthermore advantageous for the profile element to be connected to the laterally corresponding upper flange of the correspondingly allocated frame element by means of a screw and sleeve assembly. Such a screw and sleeve assembly is structurally very simple, yet still highly effective and stable.

In this context, it has often been found to be advantageous for the profile element to have a free leg on its end, to which leg the screw and sleeve assembly is fastened. The free leg can thus be deformed, for example bent, with respect to the remaining part of the profile element so as to optimize the transmission of force between the profile element and the screw and sleeve assembly.

A further advantageous embodiment provides that the guide of the bearing element extends at least substantially horizontally. As a result, the accident forces, which are in particular introduced horizontally in the longitudinal direction of the vehicle, can be absorbed in a particularly favorable manner and passed on to the corresponding frame element by means of the weakening device.

Furthermore, it has been found to be advantageous for the respective driver to extend at least substantially horizontally. This results in a particularly favorable application of force in the horizontal direction or in the longitudinal direction of the vehicle via the respective driver.

For the described weakening device to be able to be used in a driver's cab comfort bearing, it has been found to be advantageous to arrange the bearing element at the end of a driver of a stabilizer element, in particular a stabilizer rocker, the driver being provided on each side of the vehicle.

For the described weakening device to be able to be used in a driver's cab standard bearing as an alternative to this, it has been found to be advantageous for a respective lateral driver's cab bearing to be mounted in the guide by means of a corresponding spring-damper element via the corresponding bearing element on the laterally allocated, frame-side bracket.

Further advantages, features and details of the invention arise from the following description of a preferred exemplary embodiment as well as with the aid of the drawings.

### BRIEF DESCRIPTION OF THE DRAWINGS

FIG. 1 is a sectional side view of a bearing arrangement for a driver's cab of a lorry having a driver's cab comfort bearing, having a driver of a stabilizer element provided on the respective side of the vehicle, the driver being connected to a non-visible, laterally corresponding spring-damper element of a driver's cab bearing and being mounted in a guide with a rear end with a bearing element on a laterally corresponding frame-side bracket, along which guide the bearing element can be displaced in the event of accident-induced application of force, wherein the bearing element is shown here in an initial position and is connected to a laterally allocated frame element of a support frame of the lorry via a weakening device;

FIG. 2 is a sectional side view of the bearing arrangement according to FIG. 1, wherein the corresponding bearing element of the driver has been rearwardly displaced as a result of an accident-induced application of force along the corresponding guide provided in the associated bracket, as a result of which the laterally allocated frame element of the support frame has been weakened or deformed in a targeted manner by means of the weakening device, via which the bearing element is connected to the frame element; and

FIG. 3 is a further, sectional side view of the bearing arrangement according to FIGS. 1 and 2, wherein the frame element of the support frame has been bent upwards in the vertical direction of the vehicle as a result of the weakening in the further course of the accident scenario according to FIG. 2.

### DETAILED DESCRIPTION OF THE DRAWINGS

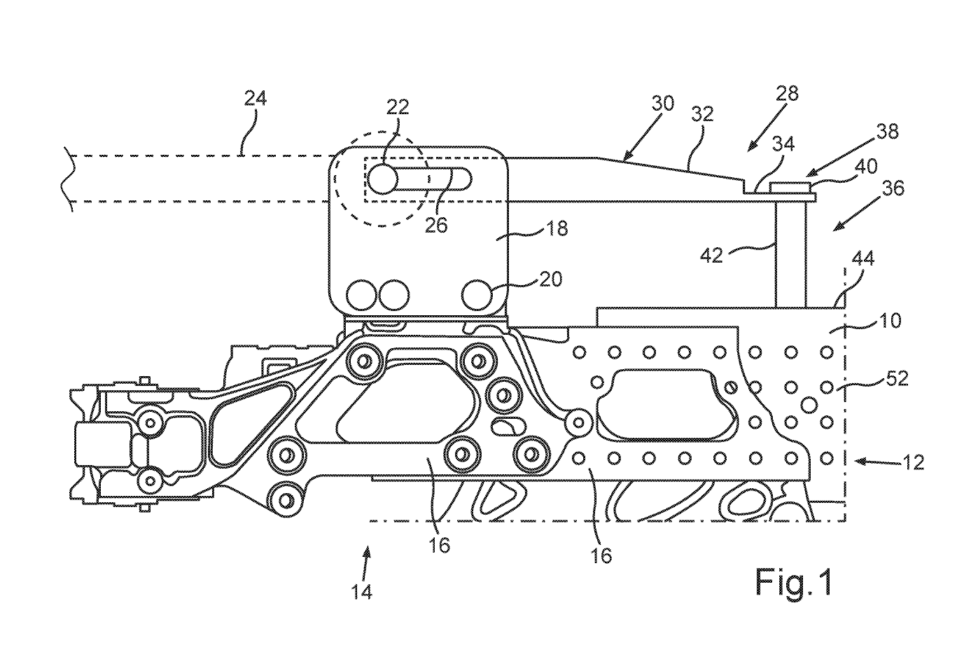

FIG. 1 shows a bearing arrangement for a driver's cab of a lorry having a so-called driver's cab comfort bearing in a sectional side view. Firstly, a frame element 10 in the form of a frame longitudinal beam which is substantially U-shaped in the cross section can be seen on the left side of the vehicle, viewed in the forward travel direction, which forms a support frame 12 of the lorry with a non-visible, mirror-symmetrical frame element or frame longitudinal beam on the opposite side of the vehicle. This support frame 12 is formed, for example, in a conventional manner by the respective frame longitudinal beams 10 being held over several cross members at a preferably parallel distance from one another. For example, several axles and a body of the lorry are supported on the support frame 12.

On the front side, the support frame 12 comprises a frame construction 14 having respective frame elements 16 which extend the actual frame longitudinal beams 10 towards the front and are connected, for example, to the laterally corresponding frame longitudinal beam 10 via respective screw connections. The frame construction 14 comprises, among other things, an underride guard as well as a front cross member, to which, for example, a front module can be fastened.

On the upper side of the respective frame element 16 of the frame construction 14, a bracket 18 is supported on each side of the vehicle and is fastened by several screw connections 20. This bracket 18 is used to receive a bearing element 22 at the rear end of a driver 24 which is provided on each side of the vehicle and is only indicated with dashed lines in the figures, the driver being part of a stabilizer element in the form of a stabilizer rocker or similar in a manner which is described below in more detail. Each of the two lateral drivers 24 of the stabilizer rocker or similar stabilizer element is thus connected on the front side to an associated spring-damper element, by means of which the driver's cab is supported on one side towards the bottom on the laterally corresponding frame element 16 of the frame construction 14 of the support frame 12, and on which the support structure of the driver's cab is supported on the upper side. In the present case, it is a driver's cab comfort bearing. For this reason, the laterally indicated driver 24 is also indicated only by dashed lines.

However, the bearing arrangement described below can also be readily used in the case of a driver's cab standard bearing. This will be referred to later.

As can be seen in FIG. 1, the respective bearing element 22 is mounted at the rear end of the corresponding driver 24 in a guide 26 of the laterally associated bracket 18. In the present case, this guide 26 is formed substantially as an oblong hole or similar slot. In the initial position, the respective bearing element 22 is located on each side of the vehicle at the front end of the associated guide 26 of the corresponding respective laterally associated bracket 18.

Furthermore, it can be seen from FIG. 1 that the bearing element 22 is connected to the laterally allocated frame element 10 of the support frame via a weakening device 28 which is described in more detail below. In this context it should be noted that, in the present case, the respective frame element 10 and the respective frame element 16 on each side of the vehicle are to be considered as an interrelated component. Where applicable, it would also be conceivable for the bracket 18 to be located on the frame element 10 or for the weakening device 28 to be supported on the frame element 16.

In the present case, the weakening device 28 comprises a profile element 30 which is designed to be at least substantially U-shaped in cross section over the at least predominant longitudinal course. Lateral legs 32 of the profile element 30 taper towards the rear, wherein, in the end region, the profile element 30 only has a lower leg 34, in the region of which the legs 32 no longer extend. In the present case, the leg 34 is therefore formed to be substantially even and flat. The leg 34 is thus used to receive a screw and sleeve assembly 36, the screw 38 of which passes through the leg 34 and is supported thereon with a head 40. On the underside of the leg 34, a sleeve 42 is supported with an upper end, the sleeve 42 being supported towards the bottom on an upper flange 44 of the frame element 10. The screw 38 is thus screwed to the upper flange 44 on its side facing away from the head 40. For this purpose, either a thread can be provided in the upper flange 44 or a lock nut can be provided on the underside of the upper flange 44, by means of which lock nut the screw 38 which passes through the upper flange 44 in the region of a passage opening is locked. As a result in any case, a substantially angular configuration of the weakening device 28 is achieved, wherein, in the present case, the profile element 30, at least substantially in the extension of the guide 26 which likewise extends approximately horizontally, also extends at least substantially horizontally and in the longitudinal direction of the vehicle. In contrast, the screw and sleeve assembly 36 extends at least substantially in the vertical direction of the vehicle. On the opposite side of the vehicle, a corresponding construction is provided in a mirror-symmetrical design.

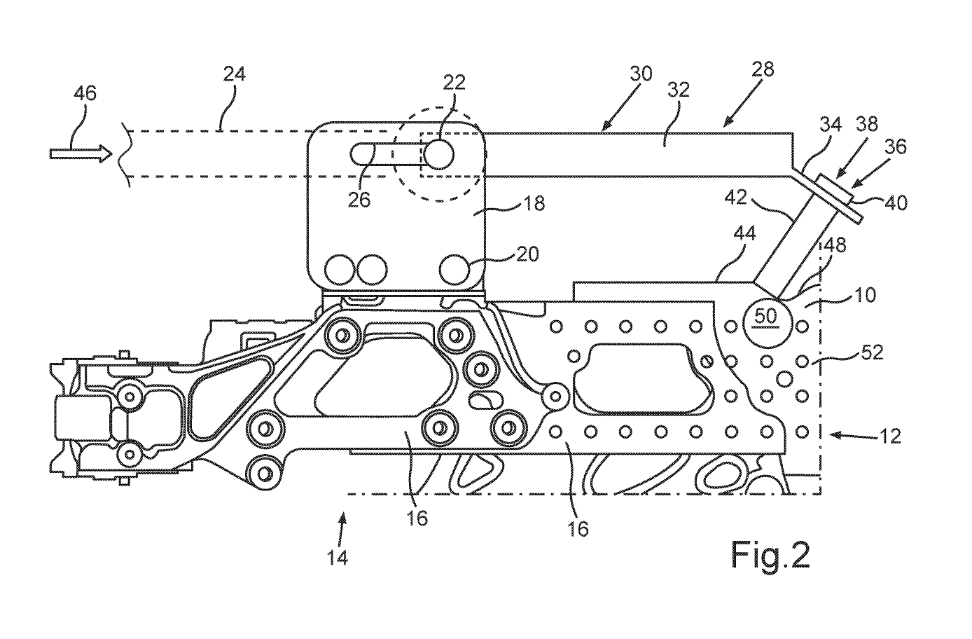

Therefore, if the driver's cab is applied with an accident-induced force, for example when driving into an obstacle disposed in front of it, i.e., in the event of a collision, for example, as is shown with an arrow 46 in FIG. 2, this also results in an accident-induced introduction of force into the stabilizer element having the respective lateral drivers 24, whereby the bearing element 22 thereof is correspondingly rearwardly displaced.

By means of FIG. 2, this is shown in a sectional side view of the bearing arrangement, analogous to FIG. 1. In this case, it can be seen that the respective lateral bearing element 22 has been displaced from the foremost initial position into a rearmost position as a result of the accident-induced application of force according to the arrow 46, as a result of which the corresponding weakening device 28 has also been applied with a corresponding accident force. This accident-induced application of force consequently also results in a rearward displacement of the respective profile element 30 of the weakening device 28, whereby the screw and sleeve assembly 36 arranged at least substantially perpendicularly in the initial position has correspondingly been rearwardly displaced in the region of its head 40. This rearward displacement results in a corresponding deformation or weakening of the frame element 10 in the region of the upper flange 44. More precisely, the upper flange 44 is provided with a recess, notch or similar weakening as a result of the rearward displacement of the screw and sleeve assembly 36 in the region of its head 40. Since a material weakening in the form of a passage opening 50 in a leg 52 of the frame element 10 is provided in the region of the fastening point of the screw and sleeve assembly 36, a targeted support of this weakening 48 thereby results.

FIG. 2 also shows that the profile element 30 has been displaced substantially rearwardly in the longitudinal direction of the vehicle, i.e., corresponding to the orientation of the guide 26 or the direction of force according to the arrow 46, but that the leg 34 of the profile element 30 has been bent on a downward incline by the effect of the force. The bending of the leg 34 results in a desired introduction of force into the upper flange 44 of the frame element 10 such that the desired weakening 48 results there.

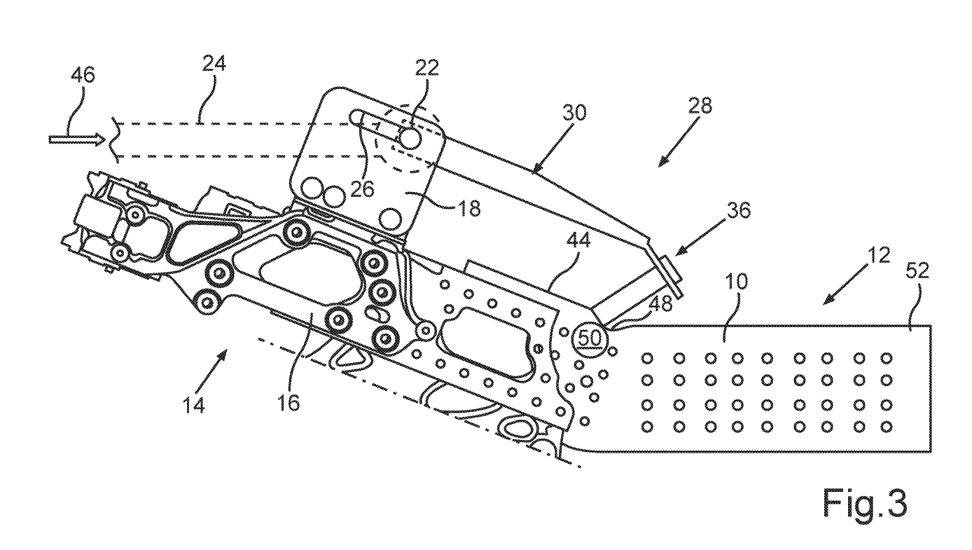

The further mode of operation for weakening the respective frame element 10 will now be explained by means of FIG. 3, which shows the bearing arrangement according to FIGS. 1 and 2 in the further course of the accident scenario. As a result of the further introduction of force of the corresponding accident force according to the arrow 46, a deformation or buckling process occurs in particular in the further course of the accident scenario in the region of the material weakening 48, in which process the frame elements 10 maintain their orientation in the longitudinal direction of the vehicle but are bent upwards with their front ends or with the ends of the frame elements 16. Overall, this results in a preferred accident performance of the support frame 12.

The respective upper flange 44 of the associated frame element 10 is thus weakened in a targeted manner by the screw and sleeve assembly 36, as a result of which the frame element 10 can act as a whole as an energy-absorbing crash element by being able to be bent upwards. Depending on the extent to which the respective bearing element 22 is rearwardly displaced within the guide 26, a different weakening 48 or design of the upper flange 44 results in the forced deformation region (opening 50), as a result of which the starting forces can be adjusted at the start of deformation and thus the connecting forces of the screw connections can be adjusted when the frame elements 10 are bent upwards. As a result, an improved accident performance of the lorry is achieved.

As has already been explained above, the bearing arrangement can also be used in a driver's cab standard bearing. In this case, the stabilizer element in the form of the stabilizer rocker described in connection with the exemplary embodiment above is omitted, the stabilizer rocker comprising the respective lateral drivers 24 indicated only by dashed lines in the figures. In fact, in the case of the driver's cab standard bearing, a respective lateral driver's cab bearing is mounted directly in the guide 26 on the laterally allocated, frame-side bracket 18 by means of a corresponding spring-damper element, via the corresponding bearing element 22. In this respect, between the driver's cab standard bearing and the driver's cab comfort bearing, a different bearing of the driver's cab as a whole on the respective bracket 18 only results by means of the corresponding bearing element 22.

For the functioning of the weakening device 28, this means that the targeted weakening of the frame element 10 of the support frame 12 is initiated by the accident-induced displacement of the bearing element 22 along the guide 26 both in the case of the driver's cab standard bearing and in the case of the driver's cab comfort bearing.

1.-10. (canceled)

11. A bearing arrangement for a driver's cab of a lorry, comprising:
a frame-side bracket which is fastened to a frame element of a support frame of the lorry and which includes a guide; and
a bearing element of a driver's cab bearing, wherein the bearing element is displaceable along the guide in an event of an accident-induced application of force;
wherein the bearing element is connected to the frame element of the support frame via a weakening device, wherein the frame element of the support frame is weakened by the weakening device when the bearing element is displaced along the guide.

12. The bearing arrangement according to claim 11, wherein the weakening device is connected to an upper flange of the frame element and wherein the upper flange is weakened when the bearing element is displaced along the guide.

13. The bearing arrangement according to claim 11, wherein the frame element has a leg which has a material weakening in a fastening region of the weakening device.

14. The bearing arrangement according to claim 13, wherein the material weakening is an opening.

15. The bearing arrangement according to claim 11, wherein the weakening device includes a profile element which is connected to the bearing element and extends at least substantially in a direction of the guide.

16. The bearing arrangement according to claim 15, wherein the profile element is connected to an upper flange of the frame element via a screw and sleeve assembly.

17. The bearing arrangement according to claim 16, wherein the profile element has a leg and wherein the screw and sleeve assembly is fastened to the leg.

18. The bearing arrangement according to claim 11, wherein the guide extends at least substantially horizontally.

19. The bearing arrangement according to claim 11, wherein the bearing element is disposed at an end of a driver of a stabilizer element and wherein the driver is provided on each side of the lorry.

20. The bearing arrangement according to claim 19, wherein the driver extends at least substantially horizontally.

21. The bearing arrangement according to claim 11, wherein the driver's cab bearing is a driver's cab standard bearing.
